(19) United States
(12) Patent Application Publication
(10) Pub. No.: US 2024/0204637 A1
(43) Pub. Date: Jun. 20, 2024

(54) OPTIMIZED SKEW IN INTERIOR PERMANENT MAGNET SYNCHRONOUS MOTORS

(71) Applicant: STEERING SOLUTIONS IP HOLDING CORPORATION, Saginaw, MI (US)

(72) Inventors: Shuvajit Das, Sterling Heights, MI (US); Rakibul Islam, Troy, MI (US); Mojtaba Bahrami Kouhshahi, Ann Arbor, MI (US); Alejandro Pina Ortega, Grand Blanc, MI (US)

(21) Appl. No.: 18/083,436

(22) Filed: Dec. 16, 2022

(51) Int. Cl. H02K 29/03; B62D 5/04; H02K 1/276; H02K 1/278

(52) U.S. Cl. CPC H02K 29/03; B62D 5/0403; B62D 5/046; H02K 1/276; H02K 1/278; H02K 2201/06

(57) ABSTRACT

A system includes an electric motor, a rotor associated with electric motor, a first pole of the rotor, and a first magnet stack associated with the first pole. The first magnet set includes a set of magnets disposed proximate the rotor arranged according to a skewed arrangement and including at least a first magnet having a first length, a second magnet having a second length, and a third magnet having a third length.

### TECHNICAL FIELD

This disclosure relates to electric motors and in particular to an optimized skew in permanent magnet synchronous motors.

### BACKGROUND OF THE INVENTION

A vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system and/or other features of the vehicle may include one or more electric motors. Such electric motors may comprise permanent magnet synchronous motors (e.g., such as interior permanent magnet synchronous motors, surface mounted permanent magnet synchronous motors, and/or the like).

### SUMMARY OF THE INVENTION

This disclosure relates generally to electric motors.

An aspect of the disclosed embodiments includes a system that includes an electric motor, a rotor associated with electric motor, a first pole of the rotor, and a first magnet stack associated with the first pole. The first magnet set includes a set of magnets disposed proximate the rotor arranged according to a skewed arrangement and including at least a first magnet having a first length, a second magnet having a second length, and a third magnet having a third length.

Another aspect of the disclosed embodiments includes an electric motor that includes a rotor, a first pole of the rotor, and a first magnet stack associated with the first pole. The first magnet stack includes a set of magnets disposed proximate the rotor arranged according to a skewed arrangement. The set of magnets includes at least a first magnet having a first length, a second magnet having a second length, and a third magnet having a third length. The first length is the same as the third length.

Another aspect of the disclosed embodiments includes a method for controlling cogging torque of an electric motor. The method includes providing, at a first magnet stack of a first pole of a rotor associated with the electric motor, a first set of magnets. The method also includes arranging magnets of the first set of magnets according to a six-step V-skewed arrangement. The first set of magnets includes a first magnet having a first axial length, a second magnet having a second axial length, a third magnet having a third axial length, a fourth magnet having a fourth axial length, a fifth magnet having a fifth axial length, and a sixth magnet having a sixth axial length. The first axial length is the same as the third axial length, the fourth axial length, and the sixth axial length. The second axial length is one of the same as the first axial length and less than the first axial length, and the fifth axial length is one of the same as the fourth axial length and less than the fourth axial length.

These and other aspects of the present disclosure are disclosed in the following detailed description of the embodiments, the appended claims, and the accompanying figures.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates a vehicle according to the principles of the present disclosure.

FIGS. 2A and 2B generally illustrate a rotor according to the principles of the present disclosure.

FIGS. 3A-3C generally illustrate a portion of an interior permanent magnet synchronous motor according to the principles of the present disclosure.

FIGS. 4A and 4B generally illustrate a portion of a surface mounted permanent magnet synchronous motor according to the principles of the present disclosure.

FIG. 5 is a flow diagram generally illustrating a cogging torque control method according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system and/or other features of the vehicle may include one or more electric motors. Such electric motors may comprise permanent magnet synchronous motors or machines (PMSM) (e.g., such as interior permanent magnet synchronous motors or machines (IPMSM), surface mounted permanent magnet synchronous motors (SMPMSM), and/or the like).

PMSMs are often used in traction applications due to a higher torque and power density of such PMSMs. Typically, a PMSM has a relatively higher level of cogging torque and back electromagnetic force (BEMF) harmonics, which are essentially reduced by a skew arrangement in the rotor of the PMSM (e.g., such as a step skewed rotor implementation in electric machines, which may provide for a relatively easy manufacturing process).

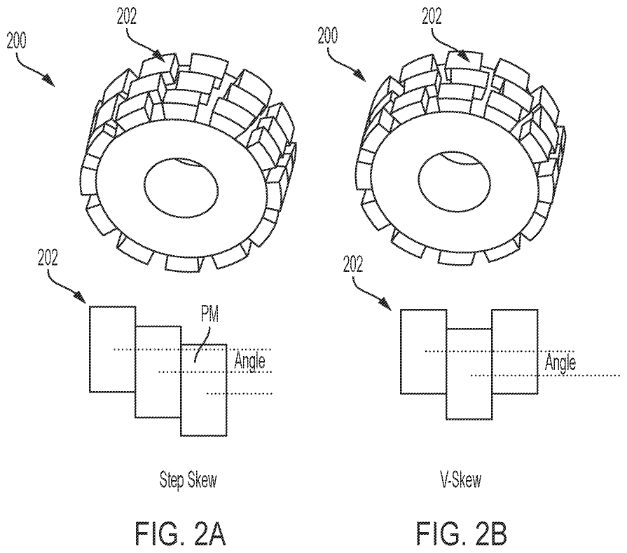

However, a step skewed rotor may experience axial force variation on the top and bottom of a rotor stack. To remedy such axial force variation, a V-shaped skew may be implemented, which may provide similar cogging torque and torque ripple reduction as the step skew with a balanced axial distribution of forces. FIGS. 2A and 2B generally illustrate a rotor 200 of an SMPMSM. As is generally illustrated in FIG. 2A, the rotor 200 may comprise a plurality of magnets 202 arranged or configured according to a stew skew arrangement. As is generally illustrated in FIG. 2B, the rotor 200 the plurality of magnets 202 may be arranged or configured according to a V-skew arrangement. This structure and basic principle of operation may also apply to an IPMSM.

The skew angle, as defined in FIGS. 2A and 2B, is determined based on the slot and pole combination of an electric machine. Such arrangements are configured to cancel or reduce a fundamental order of the cogging torque. The theoretical mechanical skew angle can be determined using Equation (1), where Nₛ is the stator slot number, p is the rotor pole number and θ_{skew} is the optimum theoretical skew angle and LCM stands for least common multiple.

$${θ}_{s k e w} = \frac{360}{L C M ( {N}_{S} , p )} \qquad ( 1 )$$

Theoretical skew as defined in Equation (1) should eliminate the cogging torque. However, due to flux leakage (e.g., which may be referred to herein as end-effect) issues on the top and bottom side of the electric machine, the theoretical skew angle may not produce the best cogging torque harmonic reduction. As such, a machine designed with the optimum theoretical skew angle may provide relatively high torque ripple.

Accordingly, systems and methods, such as those described herein, configured to provide a rotor design that provides improved cogging torque performance, improved BEMF performance, and improved torque ripple performance, may be desirable. In some embodiments, the systems and methods described herein may be configured to reduce or minimize end-effects in a V-skewed rotor. The systems and methods described herein may be configured to provide improvement in the cogging torque performance. The systems and methods described herein may be configured to use a PMSM, such as an IPMSM configured for a vehicle traction application or other suitable application and/or use an SMPMSM configured for a vehicle traction application or other suitable application.

The PMSM may be employed in applications requiring a compact, efficient, and high torque density PMSM. The PMSM may include a stator, a rotor or a rotor assembly that is disposed concentric with the stator, and a rotor shaft upon which the rotor assembly is seated, the rotor shaft extending along a rotor axis. The stator and the rotor assembly are each disposed about and extend along the rotor axis.

The stator includes a stator core and electromagnetic windings. The electromagnetic windings may be disposed proximate an inner stator periphery and may be spaced apart from an outer stator periphery. The electromagnetic windings may taper in a direction that extends from the outer stator periphery towards the inner stator periphery such that a width of each winding of the plurality of electromagnetic windings decreases in a direction that extends from the outer stator periphery towards the inner stator periphery. In some embodiments, the electromagnetic windings may taper in a direction that extends from the inner stator periphery towards the outer stator periphery. In some embodiments, the electromagnetic windings may have a substantially constant cross-sectional form that extends between the inner stator periphery and the outer stator periphery.

The rotor assembly may be rotatably disposed within the stator and may be disposed about the rotor shaft such that the PMSM is arranged as an interior rotor motor (e.g., an IPMSM). In some embodiments, the rotor assembly may be disposed about the stator such that the PMSM is configured as an exterior rotor motor (e.g., an SMPMSM).

The rotor assembly of the PMSM may include rotor segments having different rotor topologies that are axially stacked relative to each other. The different rotor topologies may employ different magnet or magnet pocket configurations such as V-shape, spoke shaped, bar or I-shaped, and/or other suitable configurations. The rotor segments having different rotor topologies may also vary at least one of rotor segment axial length, magnet length, magnet thickness, pole arc angle of magnet pockets, or magnet pocket configurations between axially stacked rotor segments.

The rotor segments or different rotors having different rotor topologies that may be stacked relative to each other may improve cogging torque, harmonics in induced voltage, and ripple in shaft torque as compared to surface permanent magnet rotors or skewed rotor segments. For example, skewed rotor segments cause adjacent skewed rotor segments to cancel or reduce total cogging. The skew angle may provide a phase shift between the adjacent skewed rotor segments and may be identical with equal amplitudes of cogging. The skewing of adjacent rotor segments may cancel certain harmonics of the induced voltage to modify the waveform and reduce torque ripple.

In some embodiments, the systems and methods described herein may be configured to provide an optimum skew angle, which is different from theoretical optimum value. The systems and methods described herein may be configured to vary axial lengths of the rotor core and magnets from ideal theoretical values. The systems and methods described herein may be configured to provide magnets having different axial lengths for different rotor steps and/or to ease manufacturing process, provide magnets having the same axial lengths. The systems and methods described herein may be configured to maintain existing rotor lamination design. The systems and methods described herein may be configured to vary an axial height of the rotor core step.

In some embodiments, the systems and methods described herein may be configured to provide an optimum skew angle, which may be different from a theoretical optimum value. For example, the product of percentage increment of skew angle (Δθ_{skew} %) and the number of slots per pole is a constant, and is defined according to:

$$Δ {θ}_{s k e w} \% * ( \frac{{N}_{s}}{{N}_{p}} ) = k \qquad ( 2 )$$

Where Nₛ=Number of slots, Nₚ=Number of pole and k=constant. Axial lengths of the rotor core and magnets are different from ideal theoretical values. For example, a 5% reduction in axial length of the center segment (e.g., center magnet or magnets) above the symmetry plane of a V-skewed rotor and corresponding 2.5% increment in the axial lengths of the top and bottom segments (e.g., top and bottom magnets), to keep the same stack length, may maximize cogging torque reduction. It should be understood that, while limited examples are provided, the percentages reduction in axial length of the center segment or other segments may include any suitable percentages.

In some embodiments, the systems and methods described herein may be configured to provide an electric motor having a rotor comprising at least a first pole. The electric motor may include a PMSM, such as an IPMSM, an SMPMSM, or other suitable PMSM. In some embodiments, the electric motor may be associated with a steering system of a vehicle. The steering system may include an EPS steering system, a SbW steering system, or other suitable steering system. The systems and methods described herein may be configured to provide a first magnet stack associated with the first pole. The first magnet stack may include a set of magnets disposed proximate the rotor arranged according to a skewed arrangement. The skewed arrangement may include V-skewed arrangement, such as a six step V-skewed arrangement or other suitable arrangement. It should be understood that the systems and methods described herein may be applicable regardless of the number of steps used in a corresponding step skew arrangement. Additionally, or alternatively, the systems and methods described herein may be applicable to step skew arrangements, V-skewed arrangements, and/or any other suitable arrangements.

The first magnet stack may also include at least a first magnet having a first length, a second magnet having a second length, and a third magnet having a third length. In some embodiments, the first length is the same as the third length and the first length (e.g., and the third length) is greater than the second length. In some embodiments, the first length and the third length are the same as the second length. In some embodiments, the set of magnets may further include a fourth magnet having a fourth length, a fifth magnet having a fifth length, and a sixth magnet having a sixth length. In some embodiments, the fourth length is the same as the third length, the fifth length is the same as the second length, and the sixth length is the same as the first length. In some embodiments, the first pole includes a second magnet stack and a third magnet stack. In some embodiments, the rotor further includes the first pole and at least one other pole.

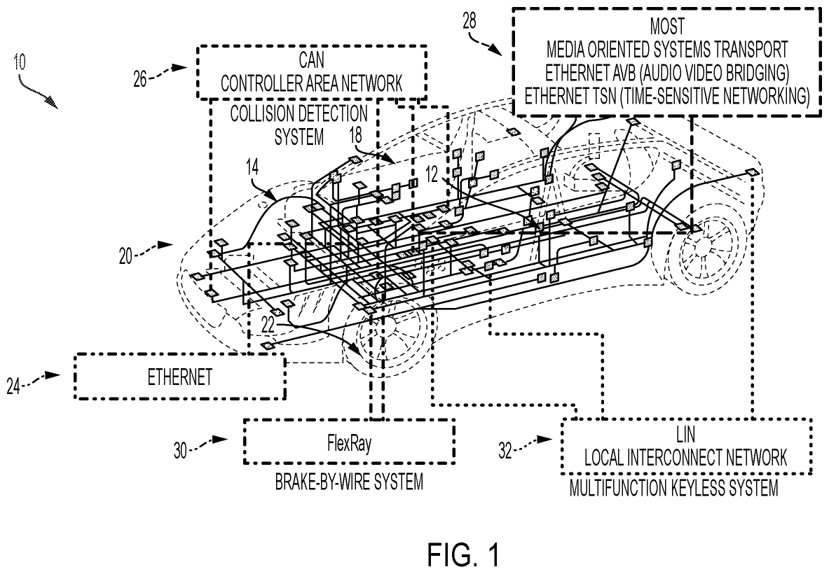

FIG. 1 generally illustrates a vehicle 10 according to the principles of the present disclosure. The vehicle 10 may include any suitable vehicle, such as a car, a truck, a sport utility vehicle, a mini-van, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by a operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semi-autonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay Component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10.

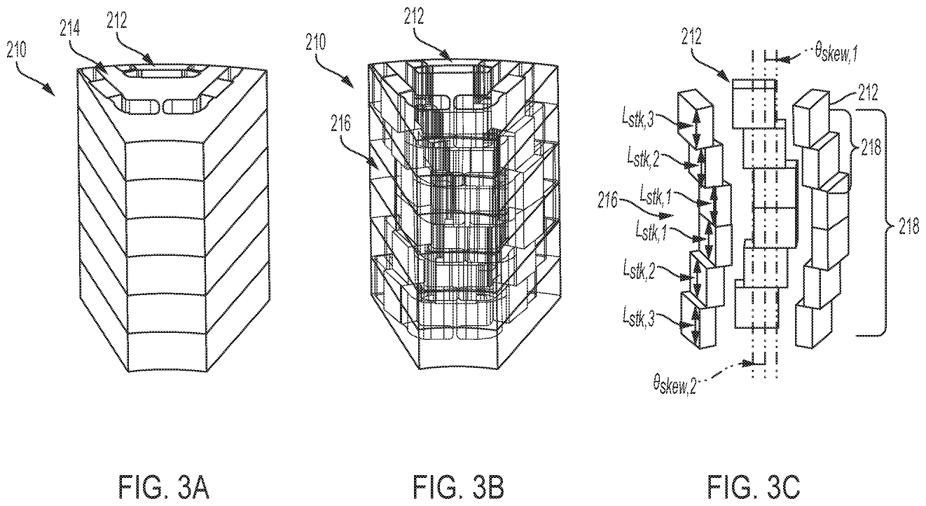

In some embodiments, the vehicle 10 may include a motor associated with the steering system or other suitable aspect or feature of the vehicle 10. As is generally illustrated in FIGS. 3A-3C, the motor may include an IPMSM comprising, at least, a rotor 210. As is generally illustrated, a portion of the rotor 210 may include a first pole 214. It should be understood that the rotor 210 may include any suitable number of poles, in addition to the pole 214 or instead of the pole 214. It should be understood that only the first pole 214 of the rotor 210 is illustrated for exemplary purposes. As such, features described with respect the first pole 214 may apply to all or at least some of the other poles of the rotor 210.

The first pole 214 may include magnet stacks 216 comprising a plurality of magnets 212. As is generally illustrated, the first pole 214 includes three magnet stacks 216 each comprising a magnet set 218 including six magnets 212. However, it should be understood that the principles of the present disclosure may be applied to poles having any suitable number of magnet stacks comprising any suitable number of magnets. The magnets 212 may include any suitable magnets, such as permanent magnets.

A subset of magnets 218′ may include three magnets 212, as is generally illustrated. The subset of magnets 218′ may include a top magnet (e.g., which may be referred to as a first magnet 212), a center magnet (e.g., which may be referred to as a second magnet 212), and a bottom magnet (e.g., which may be referred to as a third magnet 212). Each magnet 212 includes an axial length and a skew angle is defined between each pair of magnets 212. The first magnet 212 may include a first axial length, the second magnet 212 may include a second axial length, and the third magnet 212 may include a third axial length.

In some embodiments, the first axial length is the same as the third axial length (e.g., the first magnet 212, or the top magnet, is the same length as the third magnet 212, or the bottom magnet). Second axial length may be less than the first axial length and the third axial length (e.g., the second magnet 212, or the center magnet, may be shorter than the first magnet 212, or the top magnet, and the third magnet 212, or the bottom magnet). In some embodiments, the second axial length may be the same as the first axial length and the third axial length (e.g., all three magnets of the subset of magnets 218′ may be the same length). This may be ease manufacturing processes by reducing the possibility that an incorrect magnet length is placed in a particular position of the subset of magnets 218′.

In some embodiments, the magnet set 218 may further include a fourth magnet 212, a fifth magnet 212, and a sixth magnet 212 (e.g., which together comprise another subset of magnets). The fourth magnet 212 may include an axial length that corresponds to the first axial length. The fifth magnet 212 may include an axial length that corresponds to the second axial length. The sixth magnet 212 may include an axial length that corresponds to the third axial length.

Alternatively, the fourth magnet 212 may include a fourth axial length that is greater than a fifth axial length associated with the fifth magnet 212 and the same as a sixth axial length associated with the six magnet 212. The fourth axial length may be different that the first axial length.

Alternatively, the fourth axial length, the fifth axial length, and the sixth axial length may be the same. The fourth axial length may be different that the first axial length.

The skew angle between each magnet 212 of each magnet stack 216 may vary based on the axial lengths of each magnet 212 and a desired skew arrangement.

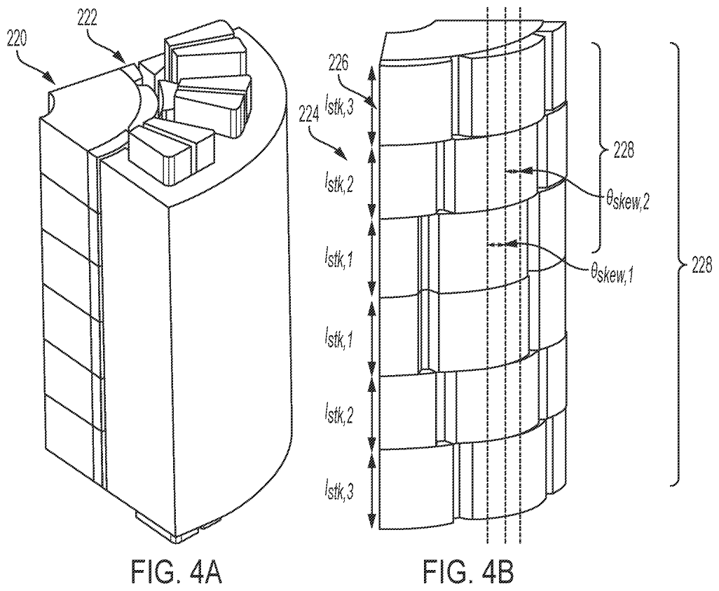

As is generally illustrated in FIGS. 4A and 4B, the motor may include an SMPMSM comprising, at least, a rotor 220. As is generally illustrated, a portion of the rotor 220 may include a first pole 222. It should be understood that the rotor 220 may include any suitable number of poles, in addition to the pole 222 or instead of the pole 222. It should be understood that only the first pole 222 of the rotor 220 is illustrated for exemplary purposes. As such, features described with respect the first pole 222 may apply to all or at least some of the other poles of the rotor 220.

The first pole 222 may include magnet stacks 224 comprising a plurality of magnets 226. As is generally illustrated, the first pole 222 includes three magnet stacks 224 each comprising a magnet set 228 including six magnets 212262. However, it should be understood that the principles of the present disclosure may be applied to poles having any suitable number of magnet stacks comprising any suitable number of magnets. The magnets 226 may include any suitable magnets, such as permanent magnets.

A subset of magnets 228′ may include three magnets 226, as is generally illustrated. The subset of magnets 228′ may include a top magnet (e.g., which may be referred to as a first magnet 2226), a center magnet (e.g., which may be referred to as a second magnet 226), and a bottom magnet (e.g., which may be referred to as a third magnet 226). Each magnet 226 includes an axial length and a skew angle is defined between each pair of magnets 226. The first magnet 226 may include a first axial length, the second magnet 226 may include a second axial length, and the third magnet 226 may include a third axial length.

In some embodiments, the first axial length is the same as the third axial length (e.g., the first magnet 226, or the top magnet, is the same length as the third magnet 226, or the bottom magnet). Second axial length may be less than the first axial length and the second axial length (e.g., the second magnet 226, or the center magnet, may be shorter than the first magnet 226, or the top magnet, and the third magnet 226, or the bottom magnet). In some embodiments, the second axial length may be the same as the first axial length and the third axial length (e.g., all three magnets of the subset of magnets 228′ may be the same length). This may be ease manufacturing processes by reducing the possibility that an incorrect magnet length is placed in a particular position of the subset of magnets 228′.

In some embodiments, the magnet set 228 may further include a fourth magnet 226, a fifth magnet 226, and a sixth magnet 226 (e.g., which together comprise another subset of magnets). The fourth magnet 226 may include an axial length that corresponds to the first axial length. The fifth magnet 226 may include an axial length that corresponds to the second axial length. The sixth magnet 226 may include an axial length that corresponds to the third axial length.

Alternatively, the fourth magnet 226 may include a fourth axial length that is greater than a fifth axial length associated with the fifth magnet 226 and the same as a sixth axial length associated with the six magnet 226. The fourth axial length may be different that the first axial length.

Alternatively, the fourth axial length, the fifth axial length, and the sixth axial length may be the same. The fourth axial length may be different that the first axial length.

The skew angle between each magnet 226 of each magnet stack 224 may vary based on the axial lengths of each magnet 226 and a desired skew arrangement.

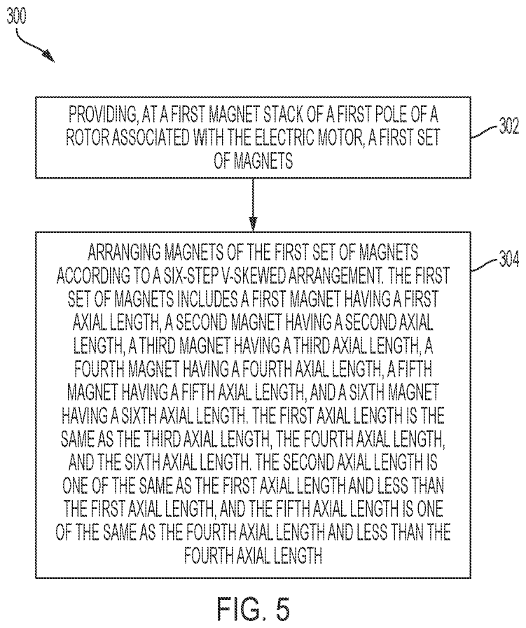

FIG. 5 is a flow diagram generally illustrating a cogging torque control method 300 according to the principles of the present disclosure. At 302, the method 300 provides, at a first magnet stack of a first pole of a rotor associated with the electric motor, a first set of magnets.

At 304, the method 300 arranges magnets of the first set of magnets according to a six-step V-skewed arrangement. The first set of magnets includes a first magnet having a first axial length, a second magnet having a second axial length, a third magnet having a third axial length, a fourth magnet having a fourth axial length, a fifth magnet having a fifth axial length, and a sixth magnet having a sixth axial length. The first axial length is the same as the third axial length, the fourth axial length, and the sixth axial length. The second axial length is one of the same as the first axial length and less than the first axial length, and the fifth axial length is one of the same as the fourth axial length and less than the fourth axial length.

In some embodiments, a system includes an electric motor, a rotor associated with electric motor, a first pole of the rotor, and a first magnet stack associated with the first pole. The first magnet set includes a set of magnets disposed proximate the rotor arranged according to a skewed arrangement and including at least a first magnet having a first length, a second magnet having a second length, and a third magnet having a third length.

In some embodiments, the electric motor includes a permanent magnet synchronous motor. In some embodiments, the permanent magnet synchronous motor includes an interior permanent magnet synchronous motor. In some embodiments, the permanent magnet synchronous motor includes a surface mounted permanent magnet synchronous motor. In some embodiments, the first length is the same as the third length. In some embodiments, the first length is greater than the second length. In some embodiments, the first length and the third length are the same as the second length. In some embodiments, the skewed arrangement includes V-skewed arrangement. In some embodiments, the V-skewed arrangement includes a six step V-skewed arrangement. In some embodiments, the electric motor is associated with a steering system of a vehicle. In some embodiments, the steering system includes an electric power steering system. In some embodiments, the steering system includes a steer-by-wire steering system. In some embodiments, the set of magnets further includes a fourth magnet having a fourth length, a fifth magnet having a fifth length, and a sixth magnet having a sixth length. In some embodiments, the fourth length is the same as the third length, the fifth length is the same as the second length, and the sixth length is the same as the first length. In some embodiments, the first pole includes a second magnet stack and a third magnet stack. In some embodiments, the rotor further includes the first pole and at least one other pole.

In some embodiments, an electric motor includes a rotor, a first pole of the rotor, and a first magnet stack associated with the first pole. The first magnet stack includes a set of magnets disposed proximate the rotor arranged according to a skewed arrangement. The set of magnets includes at least a first magnet having a first length, a second magnet having a second length, and a third magnet having a third length. The first length is the same as the third length.

In some embodiments, the second length is the same as the first length and the third length. In some embodiments, the first length is greater than the second length.

In some embodiments, a method for controlling cogging torque of an electric motor includes providing, at a first magnet stack of a first pole of a rotor associated with the electric motor, a first set of magnets. The method also includes arranging magnets of the first set of magnets according to a six-step V-skewed arrangement. The first set of magnets includes a first magnet having a first axial length, a second magnet having a second axial length, a third magnet having a third axial length, a fourth magnet having a fourth axial length, a fifth magnet having a fifth axial length, and a sixth magnet having a sixth axial length. The first axial length is the same as the third axial length, the fourth axial length, and the sixth axial length. The second axial length is one of the same as the first axial length and less than the first axial length, and the fifth axial length is one of the same as the fourth axial length and less than the fourth axial length.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such.

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A system comprising:
an electric motor;
a rotor associated with electric motor;
a first pole of the rotor; and
a first magnet stack associated with the first pole comprising a set of magnets disposed proximate the rotor arranged according to a skewed arrangement and including at least a first magnet having a first length, a second magnet having a second length, and a third magnet having a third length.

2. The system of claim 1, wherein the electric motor includes a permanent magnet synchronous motor.

3. The system of claim 2, wherein the permanent magnet synchronous motor includes an interior permanent magnet synchronous motor.

4. The system of claim 2, wherein the permanent magnet synchronous motor includes a surface mounted permanent magnet synchronous motor.

5. The system of claim 1, wherein the first length is the same as the third length.

6. The system of claim 5, wherein the first length is greater than the second length.

7. The system of claim 1, wherein the first length and the third length are the same as the second length.

8. The system of claim 1, wherein the skewed arrangement includes V-skewed arrangement.

9. The system of claim 6, wherein the V-skewed arrangement includes a six step V-skewed arrangement.

10. The system of claim 1, wherein the electric motor is associated with a steering system of a vehicle.

11. The system of claim 10, wherein the steering system includes an electric power steering system.

12. The system of claim 10, wherein the steering system includes a steer-by-wire steering system.

13. The system of claim 1, wherein the set of magnets further includes a fourth magnet having a fourth length, a fifth magnet having a fifth length, and a sixth magnet having a sixth length.

14. The system of claim 13, wherein the fourth length is the same as the third length, the fifth length is the same as the second length, and the sixth length is the same as the first length.

15. The system of claim 1, wherein the first pole includes a second magnet stack and a third magnet stack.

16. The system of claim 1, wherein the rotor further includes the first pole and at least one other pole.

17. An electric motor comprising:
a rotor;
a first pole of the rotor; and
a first magnet stack associated with the first pole comprising a set of magnets disposed proximate the rotor arranged according to a skewed arrangement and including at least a first magnet having a first length, a second magnet having a second length, and a third magnet having a third length, wherein the first length is the same as the third length.

18. The electric motor of claim 17, wherein the second length is the same as the first length and the third length.

19. The electric motor of claim 17, wherein the first length is greater than the second length.

20. A method for controlling cogging torque of an electric motor, the method comprising:
providing, at a first magnet stack of a first pole of a rotor associated with the electric motor, a first set of magnets; and
arranging magnets of the first set of magnets according to a six-step V-skewed arrangement, wherein:
the first set of magnets includes a first magnet having a first axial length, a second magnet having a second axial length, a third magnet having a third axial length, a fourth magnet having a fourth axial length, a fifth magnet having a fifth axial length, and a sixth magnet having a sixth axial length,
the first axial length is the same as the third axial length, the fourth axial length, and the sixth axial length,
the second axial length is one of the same as the first axial length and less than the first axial length, and
the fifth axial length is one of the same as the fourth axial length and less than the fourth axial length.
